(19) United States
(12) Patent Application Publication
(10) Pub. No.: US 2023/0351042 A1
(43) Pub. Date: Nov. 2, 2023

(54) PRIVACY-SENSITIVE NEURAL NETWORK TRAINING USING DATA AUGMENTATION

(71) Applicant: DeepMind Technologies Limited, London (GB)

(72) Inventors: Soham De, London (GB); Borja De Balle Pigem, London (GB); Jamie Hayes, Levenshulme (GB); Samuel Laurence Smith, London (GB); Leonard Alix Jean Eric Berrada Lancrey Javal, London (GB)

(21) Appl. No.: 18/141,273

(22) Filed: Apr. 28, 2023

Related U.S. Application Data
(60) Provisional application No. 63/335,909, filed on Apr. 28, 2022.

(51) Int. Cl. G06F 21/62

(52) U.S. Cl. CPC G06F 21/6245

(57) ABSTRACT

Methods, systems, and apparatus, including computer programs encoded on a computer storage medium, for privacy-sensitive training of a neural network. In one aspect, a method includes training a set of neural network parameters of the neural network on a set of training data over multiple training iterations to optimize an objective function. Each training iteration includes: sampling a batch of network inputs from the set of training data; determining a clipped gradient for each network input in the batch of network inputs; and updating the neural network parameters using the clipped gradients for the network inputs in the batch of network inputs.

### CROSS-REFERENCE TO RELATED APPLICATION

This application claims priority to U.S. Provisional Application No. 63/335,909, filed on Apr. 28, 2022. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a training system implemented as computer programs on one or more computers in one or more locations that performs privacy-sensitive training of a neural network.

According to one aspect, there is provided a method performed by one or more computers for privacy-sensitive training of a neural network. The method includes: training a set of neural network parameters of the neural network on a set of training data over multiple training iterations to optimize an objective function, including, at each training iteration: sampling a batch of network inputs from the set of training data; determining a clipped gradient for each network input in the batch of network inputs, including, for each network input in the batch of network inputs: generating multiple augmented versions of the network input, wherein each augmented version of the network input results from applying a respective augmentation transformation to the network input; determining, for each of the multiple augmented versions of the network input, a gradient of the objective function for the augmented version of the network input; determining a combined gradient for the network input by combining the gradients determined for the multiple augmented versions of the network input; and generating the clipped gradient for the network input by clipping the combined gradient for the network input; and updating the neural network parameters using the clipped gradients for the network inputs in the batch of network inputs.

In some implementations, generating the multiple augmented versions of the network input includes: obtaining a multiple augmentation transformations, including, for each augmentation transformation, randomly sampling parameters defining the augmentation transformation; and generating each augmented version of the network input by applying a respective augmentation transformation to the network input.

In some implementations, determining a gradient of the objective function for an augmented version of the network input includes: processing the augmented version of the network input using the neural network, in accordance with current values of the neural network parameters of the neural network, to generate a corresponding network output; and determining gradients of the objective function with respect to the neural network parameters of the neural network when the objective function is evaluated on the network output.

In some implementations, determining the combined gradient for the network input includes averaging the gradients determined for the plurality of augmented versions of the network input.

In some implementations, for one or more of the network inputs, generating the clipped gradient for the network input includes scaling the combined gradient for the network input to cause a norm of the combined gradient for the network input to satisfy a clipping threshold.

In some implementations, scaling the combined gradient for the network input to cause the norm of the combined gradient for the network input to satisfy the clipping threshold includes scaling the combined gradient for the network input by a scaling factor defined as a ratio of: (i) the clipping threshold, and (ii) the norm of the combined gradient for the network input.

In some implementations, the method further includes, before updating the neural network parameters using the clipped gradients for the network inputs in the batch of network inputs: generating a set of noise parameters, including randomly sampling the noise parameters from a noise distribution; and applying the noise parameters to the clipped gradients for the network inputs in the batch of network inputs.

In some implementations, the noise distribution includes a Gaussian noise distribution.

In some implementations, the neural network does not include any batch normalization layers.

In some implementations, the neural network includes group normalization layers.

In some implementations, the neural network is configured to process a network input that includes an image.

In some implementations, the neural network is configured to process a network input that includes audio data.

In some implementations, the neural network is configured to process a network input that includes electronic medical record data.

In some implementations, the neural network is configured to process an input that includes textual data.

In some implementations, the neural network includes one or more convolutional neural network layers.

In some implementations, the objective function includes a classification loss.

In some implementations, at each training iteration, the batch of network inputs includes at least 4000 network inputs.

In some implementations, generating multiple augmented versions of the network input includes generating at least 8 augmented versions of the network input.

According to another aspect, there is provided a system of one or more non-transitory computer storage media storing instructions that when executed by one or more computers cause the one or more computers to perform operations of the abovementioned method.

According to another aspect, there is provided a system of one or more computers and one or more storage devices communicatively coupled to the one or more computers, where the one or more storage devices store instructions that, when executed by the one or more computers, cause the one or more computers to perform operations of the abovementioned method.

Throughout this specification, a “batch” of network inputs can refer to a set of one or more network inputs. For instance, a batch of network inputs can include 5 network inputs, 10 network inputs, 100 network inputs, 1000 network inputs, 5000 network inputs, or any other appropriate number of network inputs.

The neural network can have any appropriate neural network architecture. For example, the neural network can include any appropriate types of neural network layers (e.g., fully-connected layers, convolutional layers, attention layers, recurrent layers, etc.) in any appropriate numbers (e.g., 5 layers, 10 layers, or 100 layers) and connected in any appropriate configuration (e.g., as a linear sequence of layers or as a directed graph of layers).

The neural network can be configured to perform any appropriate machine learning task.

In particular, the neural network can be configured to process any appropriate network input, e.g., including one or more of: an image, an audio waveform, a point cloud (e.g., generated by a lidar or radar sensor), a representation of a protein, a sequence of words (e.g., that form one or more sentences or paragraphs), a video (e.g., represented a sequence of video frames), or a combination thereof.

The neural network can be configured to generate any network output that characterizes the network input. For example, the network output can be a classification output, a regression output, a sequence output (i.e., that includes a sequence of output elements), a segmentation output, or a combination thereof.

A few examples of machine learning tasks that can be performed by the neural network are described in more detail next.

In some implementations, the neural network is configured to process a network input that represents the pixels of an image to generate a classification output. The classification output can include a respective score for each class in a set of classes, where the score for a class defines a likelihood that the image is included in the class. A few examples of classification tasks that can be performed by the neural network are described next.

In one example, the neural network performs an object classification task. In this example, each class in the set of classes corresponds to a respective object category, and an image is included in a class if it depicts an object in the object category corresponding to the class. Examples of object categories include, e.g., vehicle, pedestrian, bicyclist, etc.

In another example, the neural network can perform an action classification task. In this example, each class in the set of classes corresponds to a respective action, and an image is included in a class if it depicts a person performing the action corresponding to the class. Examples of actions include, e.g., sitting, standing, running, walking, etc.

In another example, the neural network can process medical images (e.g., ultrasound images, computed tomography (CT) images, or magnetic resonance (MR) images) to perform a medical classification task. In this example, each class in the set of classes corresponds to a respective medical category, and an image is included in a class if it depicts tissue that exhibits characteristics of the medical category corresponding to the class. Examples of medical categories include, e.g., cancerous tissue and non-cancerous tissue.

In another example, the neural network can process biometric images (e.g., images showing an eye of a person) to perform an identity classification task. In this example, each class in the set of classes can correspond to a respective person, and a biometric image is included in a class if it depicts (at least part of) a person corresponding to the class.

In some implementations, the neural network is configured to process a network input that represents audio samples in an audio waveform to perform speech recognition, i.e., to generate an output that defines a sequence of phonemes, graphemes, characters, or words corresponding to the audio waveform.

In some implementations, the neural network is configured to process a network input that represent words in a sequence of words to perform a natural language processing task, e.g., topic classification or summarization. To perform topic classification, the neural network generates an output that includes a respective score for each topic category in a set of possible category categories (e.g., sports, business, science, etc.). The score for a topic category can define a likelihood that the sequence of words pertains to the topic category. To perform summarization, the neural network generates an output that includes an output sequence of words that has a shorter length than the input sequence of words and that captures important or relevant information from the input sequence of words.

In some implementations, the neural network performs a machine translation task, e.g., by processing a network input that represents a sequence of text, e.g., a sequence of words, phrases, characters, or word pieces, in one language, to generate an output that can be a translation of the sequence of text into another language, i.e., a sequence of text in the other language that is a translation of the input sequence of text. As a particular example, the task can be a multi-lingual machine translation task, where the neural network is configured to translate between multiple different source language—target language pairs. In this example, the source language text can be augmented with an identifier that indicates the target language into which the neural network should translate the source language text.

In some implementations, the neural network is configured to perform an audio processing task. For example, if the network input represents a spoken utterance, then the output generated by the neural network can be a score for each of a set of pieces of text, each score representing an estimated likelihood that the piece of text is the correct transcript for the utterance. As another example, if the network input represents a spoken utterance, the output generated by the neural network can indicate whether a particular word or phrase (“hotword”) was spoken in the utterance. As another example, if the network input represents a spoken utterance, the output generated by the neural network can identify the natural language in which the utterance was spoken.

In some implementations, the neural network is configured to perform a natural language processing or understanding task, e.g., an entailment task, a paraphrase task, a textual similarity task, a sentiment task, a sentence completion task, a grammaticality task, and so on, that operates on a set of network inputs representing text in some natural language.

In some implementations, the neural network is configured to perform a text to speech task, where the network input represents text in a natural language or features of text in a natural language and the network output is a spectrogram, a waveform, or other data defining audio of the text being spoken in the natural language.

In some implementations, the neural network is configured to perform a health prediction task, where the network input represents data derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

In some implementations, the neural network is configured to perform a text generation task, where the network input represents a sequence of text, and the output is another sequence of text, e.g., a completion of the input sequence of text, a response to a question posed in the input sequence, or a sequence of text that is about a topic specified by the first sequence of text. As another example, the network input can represent data other than text, e.g., an image, and the output sequence can be text that describes the data represented by the network inputs.

In some implementations, the neural network is configured to perform a genomics task, where the network input represents a fragment of a DNA sequence or other molecule sequence and the output includes, e.g., a promoter site prediction, a methylation analysis, a prediction for functional effects of non-coding variants, and so on.

In some implementations, the neural network is configured to perform a protein modeling task, e.g., where the network input represents a protein and the network output characterizes the protein. For example, the network output can characterize a predicted stability of the protein or a predicted structure of the protein.

In some implementations, the neural network is configured to perform a point cloud processing task, e.g., where the network input represents a point cloud (e.g., generated by a lidar or radar sensor) and the network output characterizes, e.g., a type of object represented by the point cloud.

In some implementations, the neural network is configured to perform a combination of multiple individual machine learning tasks, e.g., two or more of the machine learning tasks mentioned above. For example, the neural network can be configured to perform multiple individual natural language understanding tasks, with the network inputs processed by the neural network including an identifier for the individual natural language understanding task to be performed on network input.

The subject matter described in this specification can be implemented in particular embodiments so as to realize one or more of the following advantages.

The training system described in this specification can train a neural network to perform a machine learning task using a privacy-sensitive training technique that mitigates the risk of privacy attacks. A privacy attack on a neural network can refer to operations performed to extract information about the set of training data used to train the neural network, e.g., in the form of revealing individual training examples (e.g., including individual network inputs) that were used during the training of the neural network. Privacy attacks can result in the exposure of confidential information. The risk of privacy attacks, if left unaddressed, can limit the deployment of machine learning models that are trained on sensitive datasets.

Training a neural network using data augmentation can refer to generating augmented versions of network inputs, i.e., by applying augmentation transformations to network inputs, and then using the augmented versions of the networks inputs for training the neural network. Training a neural network using data augmentation can increase the robustness and prediction accuracy of the neural network, e.g., by reducing the likelihood of overfitting, and by reducing the amount of training data required to train the neural network. Reducing the amount of training data required to train the neural network can enable reduced consumption of computational resources, e.g., memory and computing power, during training. However, conventional approaches for performing data augmentation can result in a significantly increased privacy cost being incurred during training, i.e., resulting in the neural network being more vulnerable to privacy attacks. In particular, the privacy cost incurred by performing conventional data augmentation can scale linearly with the number of augmented versions that are generated for each training example.

The training system described in this specification addresses this issue by implementing a form of data augmentation that achieves the benefits of data augmentation without incurring any additional privacy loss. In particular, the training system can generate a combined gradient for a network input by combining gradients derived from multiple augmented versions of the network input, clip the combined gradient, and then use the clipped gradient to update the parameter values of the neural network. Combining the gradients derived from the augmented version of the network input enables the training system to generate a richer gradient that encodes more information from the network input. Clipping the combined gradient generated from each network input prior to using the combined gradients to update the neural network parameters limits the impact of any individual network input on the neural network parameters and thus contributes to enhancing the robustness of the neural network to privacy attacks.

We do not state or imply here that a model ‘contains’ its training dataset in the sense that there is a copy or version of that dataset in the model. Rather, a model may include (“memorize”) attributes of its training data such that in certain cases it is statistically able to generate content that is a close approximation to elements of that training data when following rules and using such attributes. Content that is repeated in the training dataset many times is more likely to be among the content the model can be induced to closely approximate. However, the incidences of such close approximations are exceptionally rare and often are produced only through specific challenges designed to produce them.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example training system that performs privacy-sensitive training of a neural network.

FIG. 2 is a flow diagram of an example process for privacy-sensitive training a neural network.

FIG. 3 is a flow diagram of an example process for determining a clipped gradient of a network input to a neural network.

FIG. 4 is a table of training and validation dataset accuracy of a neural network under various hyper-parameter calibrations.

FIG. 5A shows a plot of training and validation dataset accuracy of a neural network versus batch size of batches training examples.

FIG. 5B shows a plot of training and validation dataset accuracy of a neural network versus augmentation multiplicity of training examples.

Like reference numbers and designations in the various drawings indicate like elements.

### DETAILED DESCRIPTION

Machine learning models (e.g., neural network models) trained with standard pipelines (e.g., in the absence of privacy-sensitive training techniques) can be attacked by an adversary that seeks to reveal the training data (e.g., individual training examples) on which the model was trained. However, privacy-sensitive training of a neural network, i.e., training that mitigates privacy attacks on the neural network by an adversary, is a considerable challenge. Currently available techniques can lead to a significant degradation in neural network performance on standard machine learning tasks, e.g., image classification benchmarks. Furthermore, currently available techniques for privacy protection may perform poorly on large neural network models (e.g., large language models) in general and it has been postulated that such outcomes may be unavoidable for large models.

The training system described in this specification addresses some or all of these problems. For example, the training system can provide privacy for large over-parameterized neural network models while maintaining high performance of the neural networks on various machine learning tasks, e.g., using data augmentation, noise injection, and hyper-parameter calibration techniques. The training system may be capable of providing similar performance for privately trained neural networks as that achieved by non-privately trained neural networks.

These features and other features are described in more detail below.

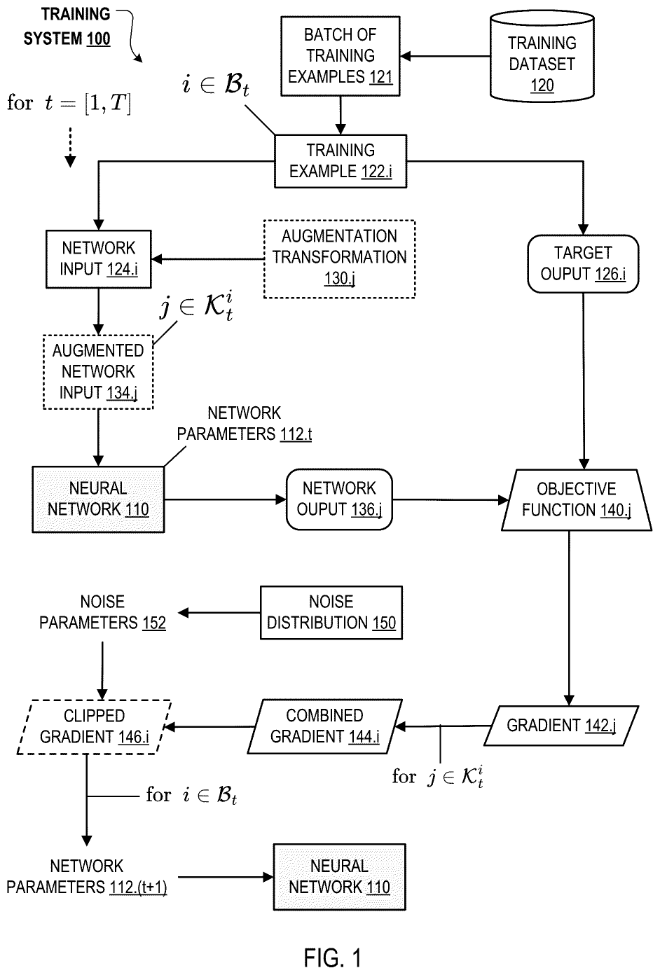

FIG. 1 shows an example training system 100 that can perform privacy-sensitive training of a neural network 110. The training system 100 is an example of a system implemented as computer programs on one or more computers in one or more locations in which the systems, components, and techniques described below are implemented.

The neural network 110 is parametrized by a set of network parameters 112 and is configured to process a network input to generate a network output. Training system 100 can train the neural network 110 on a set of training data 120 to perform a machine learning task while simultaneously providing privacy protection for the training dataset 120.

The privacy-sensitive training that training system 100 performs on the neural network 110 can be understood as a privatized learning algorithm A: [symbol] → [symbol] . In general, the privatized learning algorithm A is a randomized learning algorithm that takes a set of training data D∈ [symbol] 120 as input and generates a set of neural network parameters w∈ [symbol] = [symbol] ^{p} 112 of the neural network 110 as output. For example, the set of neural network parameters 112 may include weights (and biases) of multiple neural network layers of the neural network 110, e.g., weights of one or more feedforward neural network layers, convolutional weights of one or more convolutional neural network layers, parameter matrices and parameter vectors of one or more recurrent neural network layers, etc.

The privacy protection offered by the privatized learning algorithm is similar to one-way encryption that implement one-way functions, e.g., for private-key encryption, cryptographic hashing, etc. A one-way function is a function that is relatively easy to compute on every input but relatively hard to invert given the output of a random input, where “easy” and “hard” are in the computational complexity sense. The privatized learning algorithm may be understood in a similar sense. As described below, performing the privatized learning algorithm on a set of training data 120 to generate a set of network parameters 112 is relatively easy. However, given the set of network parameters 112, extracting a single training example 122 from the training dataset 120 is relatively hard (or unfeasible) even if an adversary has full knowledge the privatized learning algorithm. Hence, the privatized learning algorithm provides a means of “encrypting” a training dataset 120 that is used for training a neural network 110.

In this case, the set of network parameters 112 is represented as a vector for ease of description, where p is the model size (or model dimension) and corresponds to the total number of learnable network parameters 112. Training system 100 can provide privacy-sensitive training for a neural network 110 having any number of network parameters 112. For example, the model size can be 10⁵ or more, 10⁶ or more, 10⁷ or more, 10⁸ or more, 10⁹ or more, 10¹⁰ or more, 10¹¹ or more, 10¹² or more.

The training dataset D={dᵢ}ᵢ₌₁^{N} includes a total number of N training examples dᵢ 122, where N corresponds to the size of the training dataset 120. Training system 100 can use any sized training dataset 120 to train the neural network 110. For example, the training dataset 120 can include 10 or more training examples, 10² or more training examples, 10³ or more training examples, 10⁴ or more training examples, 10⁵ or more training examples, 10⁶ or more training examples, 10⁷ or more training examples, 10⁸ or more training examples, 10⁹ or more training examples, 10¹⁰ or more training examples.

The training dataset 120 can be a private dataset, e.g., a dataset that includes private information (e.g., personal, non-public, and/or sensitive information), which training system 100 aims to provide privacy for. That is, training system 100 seeks to mitigate the risk of privacy attacks on the neural network 110 that attempt to extract one or more training examples 122 (or other individualized information) from the neural network 110 that are included in the training dataset 120 on which the neural network 110 is trained. For instance, to prevent such attacks, training system 100 can establish network parameters 112 that are not strongly correlated with respect to any individual training example 122 by training the neural network 110 with respect to batches of training examples 121 that are data augmented, injected with noise, and/or have gradients clipped to clipping thresholds. With that in mind, each training example 122 may include data relating to a specific person, e.g., an image, video, and/or audio of the person, text written by the person, electronic medical records of the person, etc., that the person may not wish to be disclosed publicly.

In some implementations, the neural network 110 may be a pre-trained neural network. For example, the network parameters 112 of the neural network 110 may be pre-trained on a non-private (e.g., public) training dataset using non-privacy-sensitive training techniques. Training system 100 can then fine-tune the network parameters 112 of the neural network 110 on the private training dataset 120 to provide privacy protection for the private training dataset 120. These implementations can be advantageous for incorporating sensitive data into an existing neural network model, e.g., for fine-tuning large language models.

In some implementations, the privatized learning algorithm A implemented by training system 100 is a differentially private (DP) learning algorithm. In these cases, the DP learning algorithm provides a formal privacy guarantee for the trained neural network 110. Particularly, training system 100 can implement a DP learning algorithm to prevent an adversary that observes the output of a computation of the trained neural network 110 from inferring any property pertaining to individual training examples 122 in the training dataset 120 used during training. The strength of this privacy guarantee is generally controlled by two parameters, ε>0 and δ∈[0, 1], which together are referred to as a privacy budget (ε, δ). Broadly speaking, ε bounds the log-likelihood ratio of any particular set of network parameters 112 that can be obtained when training system 100 runs the DP learning algorithm on two datasets differing in a single training example, and δ is a small probability which bounds the occurrence of infrequent sets of network parameters 112 that violate this bound. The privacy guarantee becomes stronger as both ε and δ parameters get smaller. The training system 100 can aim to make ε a small constant and δ smaller than 1/N, where N is the size of the training dataset 120.

More formally, a DP learning algorithm A implemented by training system 100 is (ε, δ)-DP if for any two neighboring training datasets D, D′∈ [symbol] differing by a single training example 122, the DP learning algorithm satisfies:

∀S⊂ [symbol] , [symbol] [A(D)∈S]≤exp(ε) [symbol] [A(D′)∈S]+δ, (1)

where the probability [symbol] is taken over the randomness of the DP learning algorithm A. If ε and δ are small, the change in the network parameters 112 due to a single substitution in the training dataset 120 is negligible, and therefore privacy is protected. Training system 100 is capable of training the neural network 110 for high performance under a tight privacy budget, i.e., when both ε and δ are relatively small. For example, ε can be less than 1, ε can be less than 2, ε can be less than 3, ε can be less than 4, ε can be less than 5, E can be less than 6, ε can be less than 7, ε can be less than 8, ε can be less than 9, ε can be less than 10. Simultaneously, depending on the size N of the training dataset 120, δ can be less than 10⁻¹⁰, δ can be less than 10⁻⁹, δ can be less than 10⁻⁸, δ can be less than 10⁻⁷, δ can be less than 10⁻⁶, δ can be less than 10⁻⁵, δ can be less than 10⁻⁴, δ can be less than 10⁻³, δ can be less than 10⁻², δ can be less than 10⁻¹.

The privacy protection afforded by a DP learning algorithm holds under an exceedingly strong threat model: inferences about individual training examples 122 are protected in the face of an adversary that has full knowledge of the DP learning algorithm, unbounded computational power, and arbitrary side knowledge about the training dataset 120. Furthermore, the DP learning algorithm satisfies a number of advantageous properties including preservation under post-processing and a smooth degradation with multiple accesses to the same training dataset 120. These properties can be exploited by training system 100 to construct DP learning algorithms based on the combination of small building blocks that inject data augmentations and noise into operations that access the training dataset 120. Such features and others are described in more detail below.

As shown in FIG. 1, a privatized learning algorithm A is an iterative algorithm which training system 100 executes successively for each of multiple training iterations t=1,2, . . . , T to optimize an objective function [symbol] 140. Particularly, training system 100 updates the values of the network parameters w^{(t)} 112.t at each training iteration (t) according to a privatized update rule (see examples below) to progressively minimize (or maximize) the objective function 140 with respect to the network parameters 112. Training system 100 can implement the privatized update rule at each training iteration to generate a set of network parameters 112 that is not strongly correlated with any individual training example 122, thus providing privacy. However, such decorrelation can incur a “privacy cost” at each training iteration, that is, a loss of performance of the neural network 110 due to masking of training examples 122, e.g., due to data augmentations, injected noise, and/or gradients clipped to clipping thresholds. Hence, in some implementations, training system 100 aims to reduce the number of training iterations involved in optimizing the objective function 140 which can improve performance of the neural network 110. For example, training system 100 can execute 10² training iterations or less, 10³ training iterations or less, 10⁴ training iterations or less, 10⁵ training iterations or less, than may otherwise be required, e.g., to reach an acceptable level of performance (e.g., prediction accuracy).

The objective function 140 can be any appropriate objective function that measures performance of the neural network 110 on a machine learning task. For instance, the objective function can include cross-entropy loss terms, divergence loss terms, mean-squared-error (MSE) loss terms, or any other appropriate loss terms.

The detailed steps of each training iteration t=[1, T] proceed as follows.

Training system 100 samples a batch of training examples 121 from the training dataset [symbol] ₜ∈D. The number of training examples 122.i in a batch 121, that is, the size of the batch Bₜ=| [symbol] ₜ|, can be the same or differ between each training iteration. For example, a particular batch of training examples 121 may include 1 or more training examples, 5 or more training examples, 10 or more training examples, 100 or more training examples, 1000 or more training examples, 5000 or more training examples, 10000 or more training examples. The relative size of a batch 121 to the size of the training dataset 120 is referred to as the sampling ratio for the training iteration qₜ=Bₜ|N.

Each training example 122.i in the batch i∈ [symbol] ₜ includes a network input xᵢ 124.i. A training example 122.i may also include a target output yᵢ 126.i such that the corresponding network input 124.i is labeled dᵢ=(xᵢ, yᵢ), e.g., when training system 100 implements supervised learning algorithms to train the neural network 110. For instance, if the neural network 110 is a discriminative neural network, the network inputs 124.i may include images, videos, and/or audio and the target outputs 126.i may include text sequences. Conversely, if the neural network 110 is a generative neural network, the network inputs 124.i may include text sequences and the target outputs 126.i may include images, videos, and/or audio.

In some implementations, a training example 122.i can also include no target output 126.i, such that the corresponding network input 124.i is not labelled dᵢ=xᵢ. In these implementations, the training system 100 may implement unsupervised learning algorithms or reinforcement learning algorithms to train the neural network 110, e.g., where the objective function 140 includes an expected return, e.g., an expected discount sum of rewards, or a contrastive loss term. In general, the training examples 122.i can include both labeled network inputs and/or unlabeled network inputs, and the objective function 140 can include any appropriate loss terms. In some cases, network inputs can include multiple types of data (e.g., multi-modal data).

For each network input 124.i in the batch 121, training system 100 obtains at least one augmentation transformation ψⱼ 130.j for the network input 124.i. In some implementations, training system 100 may randomly sample multiple augmentation transformations 130.j, e.g., by sampling from a probability distribution over augmentation transformations. In some implementations, training system 100 may randomly sample parameters defining each of the augmentation transformations 130.j, e.g., by sampling from respective probability distributions over such parameters. As an example, if the network input 124.i includes an image, the augmentation transformations 130.j may include crops, tinting, noising, translations, rotations, dilations, shears, reflections, and/or projections of the image. Parameters defining such augmentation transformations 130.j may include a crop size, a tint color and a tint intensity, a noise variance, a displacement vector, rotation angles, a scale factor, a shear angle, a reflection angle, and/or basis vectors. As another example, if the network input 124.i includes audio data, the augmentation transformations 130.j may include adding noise, adding reverberation effects, adding microphone effects, etc. Parameters defining such augmentation transformations 130.j may include a noise variance, a reverberation time, a voice modulation pitch, etc. The augmentation transformations 130.j may include linear transformations (e.g., representable as matrices) and/or nonlinear transformations (e.g., nonlinear functions) depending on the implementation. In some cases, a nonlinear augmentation transformation 130.j may be associated with a respective neural network.

Training system 100 applies each of the augmentation transformations 130.j to the network input 124.j. Application of an augmentation transformation 130.j generates a respective augmented version of the network input \tilde{x}ⱼ=ψⱼ(xᵢ) 134.j. The number of augmented network inputs Kₜⁱ=| [symbol] ₜⁱ| is referred to as the augmentation multiplicity. The augmentation multiplicity can be the same or differ between each network input 124.i in the batch 121 and/or between each training iteration. For example, a particular augmentation multiplicity can be 1 or more, 2 or more, 5 or more, 10 or more, 20 or more, 50 or more, 100 or more, 250 or more, or 500 or more. Training system 100 can implement data augmentation of the network inputs 124.i to varying degrees to improve the performance of the neural network 110, which can be particularly advantageous on large (e.g., over-parametrized) neural network models to reduce the likelihood of overfitting.

Training system 100 processes each augmented network input j∈ [symbol] ₜⁱ using the neural network 110, in accordance with current values of the network parameters w^{(t)} 122.t, to generate a respective network output ŷⱼ 136.j for the augmented network input 134.j. This processing performed by the neural network 110 can be represented as a function ƒ_{w}^{(t)} parametrized by the network parameters 112.t according to their current values at the training iteration (t):

ŷⱼ(w^{(t)})=ƒw^{(t)}=(\tilde{x}ⱼ). (2)

Training system 100 then evaluates the network output 136.j associated with each augmented network input 134.j using the objective function 140 to generate a respective performance measure lⱼ 140.j for the augmented network input 134.j. The performance measure 140.j of an augmented network input 134.j generally depends on whether the corresponding network input 124.i is labelled or unlabeled, that is, has a target output 126.i. For example, a performance measure 140.j may characterize an error or likelihood between a network output 136.j and an associated target output 126.i:

lⱼ(w^{(t)})= [symbol] (ŷⱼ(w^{(t)}),yᵢ)= [symbol] (ƒ_{w}_{^{(t)}}(\tilde{x}ⱼ),yᵢ)= [symbol] (ƒ_{w}_{^{(t)}}(ψⱼ(xᵢ)),yᵢ). (3)

Training system 100 determines a gradient gⱼ 142.j for each augmented network input 134.j by differentiating its performance measure 140.j with respect to the neural network parameters 112:

$${g}_{j} ( {w}^{( t )} ) = ∇ {l}_{j} ( {w}^{( t )} ) = \frac{\partial {l}_{j} ( {w}^{( t )} )}{\partial w} , \qquad ( 4 )$$

where ∇=∂/∂w denotes the gradient operator with respect to the neural network parameters 112. For example, training system 100 can use backpropagation to determine the gradient 142.j for each augmented network input 134.j. Generally, the gradients 142.j describe how sensitive the performance 140.j of each augmented network input 134.j is to the current values of the network parameters 112.t. For instance, a gradient 142.j of an augmented network input 134.j having a relatively small norm may imply its performance 140.j is less sensitive to the current values of the network parameters 112.t, and vice versa if the gradient 142.j has a relatively large norm.

Training system 100 determines a combined gradient Gᵢ 144.i for each network input 124.i by combining the gradients 142.j of the augmented versions 134.j associated with the network input 124.i. For example, training system 100 can linearly combine the gradients 142.j as:

$${G}_{i} ( {w}^{( t )} ) = {\sum }_{j ∈ {𝒦}_{t}^{i}} {k}_{j} {g}_{j} ( {w}^{( t )} ) , \qquad ( 5 )$$

where Σⱼ kⱼ=1 and kⱼ are coefficients for each gradient 142.j of the linear combination in Eq. (5). Training system 100 can appropriately weight the gradient 142.j for each augmented network input 134.j using appropriate coefficients kⱼ, e.g., to emphasize or deemphasize the augmented network input 134.j. In some implementations, the coefficients kⱼ may correspond to probabilities or scores of a probability distribution. In some implementations, training system 100 may average the gradients 142.j such that each coefficient is kⱼ=(Kₜⁱ)⁻¹, which weighs the gradients 142.j of each augmented version 134.j equally.

Training system 100 determines a clipped gradient Cᵢ 146.i for each network input 124.i by clipping the combined gradient 144.i for the network input 124.i:

Cᵢ(w^{(t)}=clip_{C}(Gᵢ(w^{(t)})). (5)

The clipping function (clip_{C}) clips the combined gradient 144.i to a maximal norm defined by a clipping threshold C. The norm can be an L₂-norm, an Lₙ-norm, or other appropriate norm in some cases. Broadly speaking, the clipping threshold determines the maximum influence that any one network input 124.i in the batch 121 can play when training system 100 updates the network parameters 112, such that the network parameters 112 are not strongly biased towards by any particular network input 124.i. In some implementations, the clipping threshold can be about 1 or less, about 2 or less, about 3 or less, about 4 or less, about 5 or less, about 6 or less, about 7 or less, about 8 or less, about 9 or less, about 10 or less.

Training system 100 can implement hard clipping such that the norm of the combined gradient 144.i is clipped at the clipping threshold C along a piecewise linear curve. Training system 100 can also implement soft clipping such that the norm of the combined gradient 144.i is clipped at the clipping threshold C along a smooth curve. As an example of hard clipping, the clipping function can be represented as:

$${clip}_{C} : v ∈ {ℝ}^{p} ↦ min \{ 1 , \frac{C}{{‖ v ‖}_{2}} \} \cdot v ∈ {ℝ}^{p} , \qquad ( 6 )$$

which rescales its input so that its output has a maximal L₂-norm of C. In some implementations, soft clipping may be advantageous over hard clipping (e.g., for second-order optimization techniques) since the clipped gradients 146.i are generally differentiable with respect to the network parameters 112.

Training system 100 generates a set of noise parameters z 151 by randomly sampling the noise parameters 151 from a noise distribution P(z) 150. In some implementations, the noise distribution 150 is a Gaussian (normal) distribution P(z)= [symbol] (z; μ, Σ), with corresponding mean μ and variance Σ. In some further implementations, the Gaussian distribution is a spherical Gaussian distribution having zero mean such that Σ=σ²/I and μ=0, where σ is the standard deviation. However, in general, the noise distribution 150 can be any desirable noise (or probability) distribution such as a speckle distribution, a Poisson distribution, a Rayleigh distribution, a Beta distribution, among others.

Training system 100 then applies the noise parameters 151 to the clipped gradients 146.i. For example, training system 100 can linearly combine the clipped gradients 146.i with the noise parameters 151 to generate a privatized gradient F for the training iteration (t):

$$F ( {w}^{( t )} ) = \frac{C}{{B}_{t}} z + {\sum }_{i ∈ {ℬ}_{t}} {b}_{i} {C}_{i} ( {w}^{( t )} ) , \qquad ( 7 )$$

where Σᵢ bᵢ=1 and bᵢ are coefficients for each clipped gradient 146.i of the linear combination in Eq. (7). Training system 100 can appropriately weight the clipped gradient 146.i for each network input 124.i using appropriate coefficients bᵢ, e.g., to provide more or less privacy to certain training examples 122.i in the batch 121. In some implementations, the coefficients bᵢ may correspond to probabilities or scores of a probability distribution. In some implementations, training system 100 may average the clipped gradients 146.i such that each coefficient is bᵢ=(Bₜ)⁻¹, which weighs the clipped gradient 146.i of each network input 124.i equally. The privatized gradient in Eq. (7) provides privacy for the training examples 122.i because the added noise z, proportional to the clipping threshold C, is generally sufficient to mask the contribution of any training example 122.i whose clipped gradient 146.i has norm less than or equal to C.

In some implementations, training system 100 normalizes the privatized gradient F by a factor of C⁻¹ such that F→C⁻¹F. In these cases, the magnitude of the clipping threshold C does not influence the scale of the privatized update rule, which can simplify hyper-parameter calibration (discussed in more detail below).

Training system 100 updates the neural network parameters w^{(t+1)}122.(t+1) for the training iteration (t) using the clipped gradients 146.i. For example, training system 100 can implement a first-order optimization technique using the privatized gradient to establish a privatized update rule of the form:

w^{(t+1)}=w^{(t)}−ηₜF(w^{(t)}), (8)

where ηₜ is the learning rate (or step-size) for the training iteration. The learning rate can be the same or differ between training iterations. For example, training system 100 can use a constant learning rate for each training iteration, e.g., using ηₜ=η with η<1, or decay the learning rate at each training iteration, e.g., using ηₜ=η^{t} with η<1. The privatized update rule of Eq. (8) is a type of stochastic gradient descent (SGD) technique but training system 100 can use a similar privatized update rule in combination with other first-order optimization techniques, such as SGD with momentum or Adam.

As another example, training system 100 can implement a second-order optimization technique using the privatized gradient to establish a privatized update rule of the form:

w^{(t+1)}=w^{(t)}−H⁻¹(w^{(t)})·F(w^{(t)}), (9)

where H is the Hessian matrix. Training system 100 can determine the Hessian matrix by computing a gradient of the privatized gradient H=∇F, where ∇=∂/∂w denotes the gradient operator with respect to the neural network parameters 112. For example, training system 100 can use backpropagation to determine the Hessian matrix.

Training system 100 then initializes the neural network 110 with the updated neural network parameters 112.(t+1) and repeats the above process for the next training iteration (t+1) to determine another privatized update to the network parameters 112, and so on.

As described above, training system 100 performs data augmentation during the privacy-sensitive training of the neural network 110. Data augmentation as it is usually implemented in non-private training, using one augmentation per independent training example 122.i in each batch 121, may reduce both training and validation accuracy, e.g., because such data augmentation introduces variance into the gradient, thereby increasing the number of required training iterations. Using multiple augmentations 134.j per training example 122.i, as described above, can allow the training system 100 to achieve the benefits of data augmentation in privacy-sensitive training. One approach for performing multiple augmentations per training example 122.i would be to compute one clipped gradient for each augmented network input 134.j; however, this would lead to a privacy cost scaling with the number of augmentations 134.j per network input 124.i of the training example 122.i. Training system 100 addresses this issue by combining the gradients 142.j of different augmentations 134.j of the same network input 124.i into a combined gradient 144.i before clipping. In this way, the training system 100 does not increase the sensitivity of the batch gradient to any single training example 122.i, and therefore does not incur any additional privacy cost.

Training system 100 may repeat this abovementioned iterative process until one or more conditions are satisfied. For example, the one or more conditions may include training system 100 reaching a predetermined number of training iterations t=T, e.g., as determined by a hyper-parameter calibration. As another example, the one or more conditions may include that the objective function 140 evaluated on the network outputs 136.j is smaller (or larger) than a threshold value a₁, e.g., such that Σᵢⱼbᵢkⱼlⱼ(w^{(t)})> <a₁. As yet another example, the one or more conditions may include that the objective function 140 evaluated on the network outputs 136.j changes negligibly relative a threshold value a₂ with successive training iterations, e.g., such that |Σᵢⱼbᵢkⱼlⱼ(w^{(t)})−Σᵢⱼbᵢkⱼlⱼ(w^{(t-1)})|<a₂.

Note, the performance of the neural network 110 is generally influenced by a combination of multiple hyper-parameters implemented by the training system 100 throughout training. Such hyper-parameters include, but are not limited to: the number of training iterations T, the sampling ratios qₜ, the augmentation multiplicities Kₜⁱ, the clipping threshold C, the mean and variance of the noise distribution 150, the learning rates ηₜ, among others. There may be additional practical constraints that training system 100 can also consider, such as a maximum compute budget that is available for training the neural network 110 on a particular computing hardware. Training system 100 can calibrate one or more of these hyper-parameters to accommodate the best possible performance for the neural network 110 while providing privacy protection for the training dataset 120. For example, training system 100 can train multiple instances of the neural network 110 with different values for the hyper-parameters under a given compute budget and then select the best performing neural network 110 from the multiple instances.

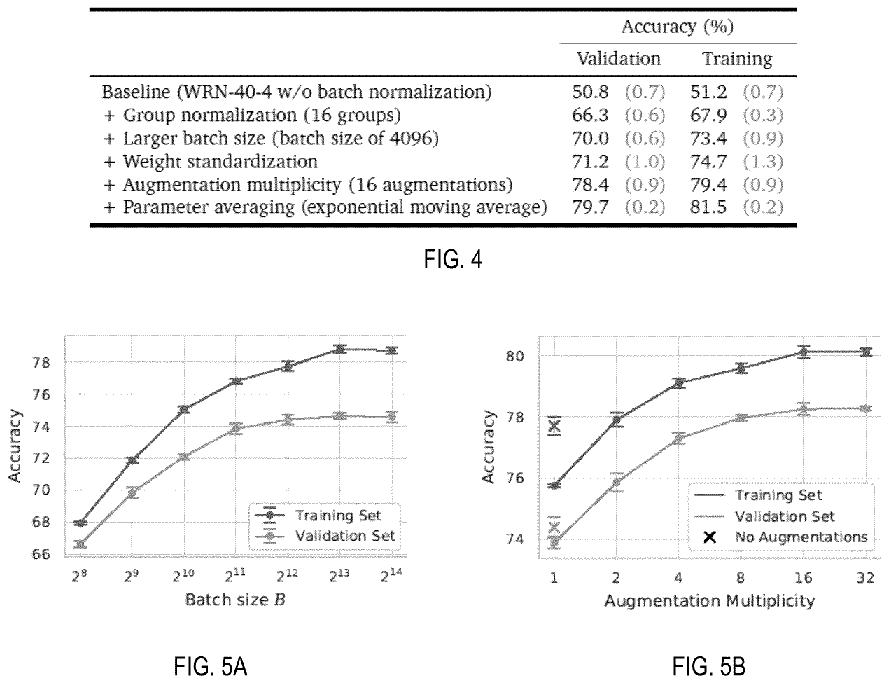

In cases when training system 100 implements a DP learning algorithm, a privacy budget (ε, δ) for the DP learning algorithm may be fixed, e.g., defining a particular target privacy protection for a training dataset 120. In these cases, training system 100 can calibrate one or more of the hyper-parameters within this privacy budget. Training system 100 can conduct such a calibration process using a privacy accountant, i.e., a numerical algorithm that provides upper bounds for the privacy budget as a function of the hyper-parameters. A review of privacy accountants for differential privacy is provided by Abadi, Martin, et al. “Deep learning with differential privacy,” Proceedings of the 2016 ACM SIGSAC Conference on Computer and Communications Security (2016). Training system 100 can combine a privacy accountant with optimization routines to optimize one hyper-parameter (e.g., the number of training iterations) given a privacy budget and then one or more other hyper-parameters (e.g., sampling ratios, augmentation multiplicities, learning rates). Examples of such optimization routines are described with respect to FIGS. 4, 5A, and 5B below.

In some implementations, the training system 100 performs parameter averaging on the set of network parameters 112 of the neural network 110. For instance, at certain training iterations, the training system 100 can set the value of each (trained) network parameter of the neural network 110 equal to a moving average (e.g., an exponential moving average) of the value of the network parameter for a window of preceding training iterations. Parameter averaging can help reduce oscillations of network parameter values during training and can improve accuracy.

In some implementations, the training system 100 applies weight standardization to one or more neural network layers of the neural network 110 at each of one or more training iterations. For instance, the training system 100 may apply weight standardization to each convolutional layer of the neural network 110. Weight standardization of a neural network layer can include normalizing the parameter values of the neural network layer, e.g., to increase stability during training. For instance, the training system 100 can apply weight standardization to a convolutional neural network layer by normalizing the rows of the weight matrix of each convolution over the fan-in of each output unit.

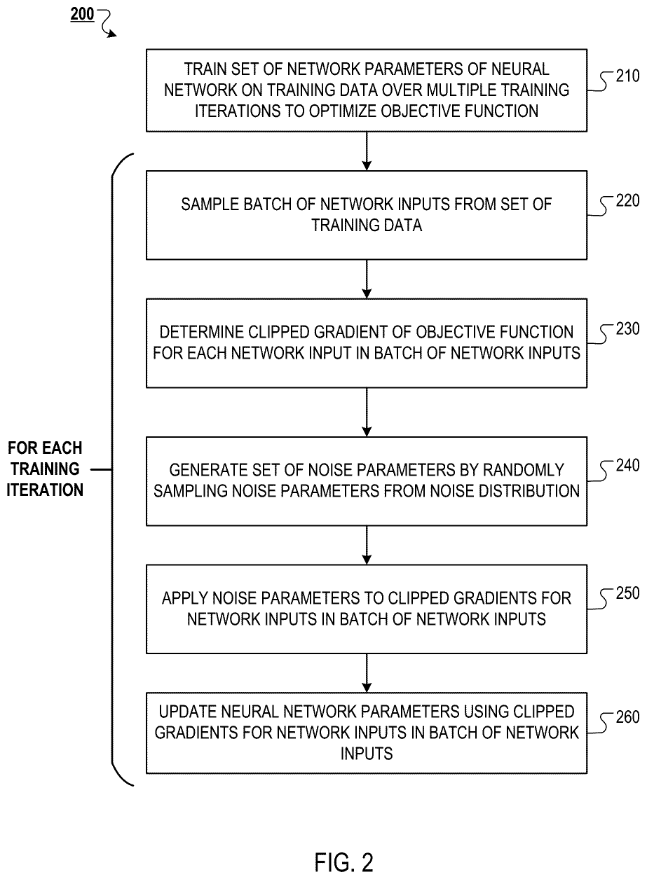

FIG. 2 is a flow diagram of an example process 200 for privacy-sensitive training of a neural network. For convenience, the process 200 will be described as being performed by a system of one or more computers located in one or more locations. For example, a training system, e.g., the training system 100 of FIG. 1, appropriately programmed in accordance with this specification, can perform the process 200.

Training system trains a set of network parameters of the neural network on a set of training data over multiple training iterations to optimize an objective function (210). In some implementations, the objective function includes a classification loss.

For each training iteration, training system performs steps 220-260:

Training system samples a batch of network inputs from the set of training data (220). In some implementations, at each training iteration, the batch of network inputs includes at least 4000 network inputs.

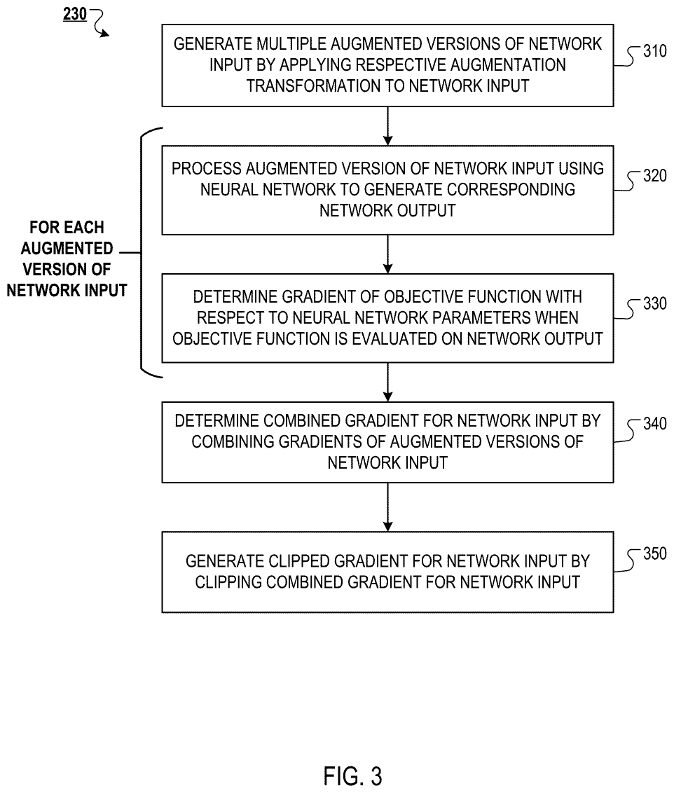

Training system determines a clipped gradient for each network input in the batch of network inputs (230). An example process for determining a clipped gradient for a network input is described in more detail below with reference to FIG. 3.

Training system generates a set of noise parameters that includes randomly sampling the noise parameters from a noise distribution (240). In some implementations, the noise distribution includes a Gaussian noise distribution.

Training system applies the noise parameters to the clipped gradients for the network inputs in the batch of network inputs (250).

Training system updates the neural network parameters using the clipped gradients for the network inputs in the batch of network inputs (260).

FIG. 3 is a flow diagram of an example process 230 for determining a clipped gradient for a network input to a neural network. For convenience, the process 230 will be described as being performed by a system of one or more computers located in one or more locations. For example, a training system, e.g., the training system 100 of FIG. 1, appropriately programmed in accordance with this specification, can perform the process 230.

Training system generates multiple augmented versions of the network input, where each augmented version of the network input results from training system applying a respective augmentation transformation to the network input (310). In some implementations, training system generates at least 8 augmented versions of the network input.

For each augmented version of the network input, training system performs steps 320-330:

Training system processes the augmented version of the network input using the neural network, in accordance with current values of the neural network parameters of the neural network, to generate a corresponding network output (320).

Training system determines a gradient of the objective function with respect to the neural network parameters of the neural network when the objective function is evaluated on the network output (330).

Training system determines a combined gradient for the network input by combining the gradients determined for the multiple augmented versions of the network input (340). In some implementations, training system determines the combined gradient for the network input by averaging the gradients determined for the multiple augmented versions of the network input.

Training system generates the clipped gradient for the network input by clipping the combined gradient for the network input (350). In some implementations, for one or more of the network inputs, training system generates the clipped gradient for the network input by scaling the combined gradient for the network input to cause a norm of the combined gradient for the network input to satisfy a clipping threshold. In some implementations, training system scales the combined gradient for the network input by a scaling factor defined as a ratio of: (i) the clipping threshold, and (ii) the norm of the combined gradient for the network input.

FIGS. 4, 5A, and 5B show experimental results of training system 100 using various hyper-parameter calibration techniques to optimize performance of Wide-ResNet neural network models with privacy-sensitive training. These techniques include replacing batch normalization with group normalization, using large batch sizes, weight standardization of convolutional layers, data augmentation, and parameter averaging. For the experiments in FIGS. 4, 5A, and 5B, training system 100 uses the CIFAR-10 training dataset to train and validate the neural networks. Particularly, for training and validation, training system 100 splits the CIFAR-10 dataset of 50K examples into a training dataset of 45K training examples and a validation dataset of 5K validation examples. Training system 100 trains the neural networks over multiple training runs on this reduced training set using DP learning algorithms under (8, 10⁻⁵)-DP.

FIG. 4 is a table of training and validation dataset accuracy of a Wide-ResNet neural network model (WRN-40-4) under various hyper-parameter calibrations. The table reports median and standard deviation values over 5 independent training runs for each additional hyper-parameter calibration. The baseline model has no batch normalization, no data augmentation, and was trained using a batch size of 256 for each training iteration. As can be seen from the table, variations to the hyper-parameters such as increasing the batch size and the augmentation multiplicity significantly increases performance of the neural network under (8, 10⁻⁵)-DP.

FIG. 5A shows a plot of training and validation dataset accuracy of a Wide-ResNet neural network model (WRN-16-4) versus batch size of batches of training examples. The mean and standard error of the training and validation dataset accuracy are plotted in FIG. 5A across 5 independent training runs for each batch size. As seen FIG. 5A, increasing the batch size leads to improved performance of the neural network under (8, 10⁻⁵)-DP.

FIG. 5B shows a plot of training and validation dataset accuracy of a Wide-ResNet neural network model (WRN-16-4) versus augmentation multiplicity of training examples. The mean and standard error of the training and validation dataset accuracy are plotted in FIG. 5B across 5 independent training runs for each augmentation multiplicity. As seen in FIG. 5B, increasing the augmentation multiplicity leads to improved performance of the neural network under (8, 10⁻⁵)-DP.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow or Haiku framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers for privacy-sensitive training of a neural network, the method comprising:
training a set of neural network parameters of the neural network on a set of training data over a plurality of training iterations to optimize an objective function, comprising, at each training iteration:
sampling a plurality of network inputs from the set of training data;
determining a clipped gradient for each network input of the plurality of network inputs, comprising, for each network input of the plurality of network inputs:
generating a plurality of augmented versions of the network input, wherein each augmented version of the network input results from applying a respective augmentation transformation to the network input;
determining, for each of the plurality of augmented versions of the network input, a gradient of the objective function with respect to the neural network parameters of the neural network when the objective function is evaluated on a network output generated by the neural network by processing the augmented version of the network input;
determining a combined gradient for the network input by combining the gradients determined for the plurality of augmented versions of the network input; and
generating the clipped gradient for the network input by clipping the combined gradient for the network input; and
updating the neural network parameters using the clipped gradients for the network inputs of the plurality of network inputs.

2. The method of claim 1, wherein generating the plurality of augmented versions of the network input comprises:
obtaining a plurality of augmentation transformations, comprising, for each augmentation transformation, randomly sampling parameters defining the augmentation transformation; and
generating each augmented version of the network input by applying a respective augmentation transformation to the network input.

3. The method of claim 1, wherein determining a gradient of the objective function for an augmented version of the network input comprises:
processing the augmented version of the network input using the neural network, in accordance with current values of the neural network parameters of the neural network, to generate a corresponding network output; and
determining gradients of the objective function with respect to the neural network parameters of the neural network when the objective function is evaluated on the network output.

4. The method of claim 1, wherein determining the combined gradient for the network input comprises:
averaging the gradients determined for the plurality of augmented versions of the network input.

5. The method of claim 1, wherein for one or more of the network inputs, generating the clipped gradient for the network input comprises:
scaling the combined gradient for the network input to cause a norm of the combined gradient for the network input to satisfy a clipping threshold.

6. The method of claim 5, wherein scaling the combined gradient for the network input to cause the norm of the combined gradient for the network input to satisfy the clipping threshold comprises:
scaling the combined gradient for the network input by a scaling factor defined as a ratio of: (i) the clipping threshold, and (ii) the norm of the combined gradient for the network input.

7. The method of claim 1, further comprising, before updating the neural network parameters using the clipped gradients for the network inputs of the plurality of network inputs:
generating a set of noise parameters, comprising randomly sampling the noise parameters from a noise distribution; and
applying the noise parameters to the clipped gradients for the network inputs of the plurality of network inputs.

8. The method of claim 7, wherein the noise distribution comprises a Gaussian noise distribution.

9. The method of claim 1, wherein the neural network does not include any batch normalization layers.

10. The method of claim 1, wherein the neural network includes group normalization layers.

11. The method of claim 1, wherein the neural network is configured to process a network input comprising an image.

12. The method of claim 1, wherein the neural network is configured to process a network input comprising audio data.

13. The method of claim 1, wherein the neural network is configured to process a network input comprising electronic medical record data.

14. The method of claim 1, wherein the neural network is configured to process a network input comprising textual data.

15. The method of claim 1, wherein the neural network comprises one or more convolutional neural network layers.

16. The method of claim 1, wherein the objective function comprises a classification loss.

17. The method of claim 1, wherein at each training iteration, the plurality of network inputs comprises at least 4000 network inputs.

18. The method of claim 1, wherein generating a plurality of augmented versions of the network input comprises generating at least 8 augmented versions of the network input.

19. One or more non-transitory computer storage media storing instructions that when executed by one or more computers cause the one or more computers to perform operations comprising:
training a set of neural network parameters of the neural network on a set of training data over a plurality of training iterations to optimize an objective function, comprising, at each training iteration:
sampling a plurality of network inputs from the set of training data;
determining a clipped gradient for each network input of the plurality of network inputs, comprising, for each network input of the plurality of network inputs:
generating a plurality of augmented versions of the network input, wherein each augmented version of the network input results from applying a respective augmentation transformation to the network input;
determining, for each of the plurality of augmented versions of the network input, a gradient of the objective function with respect to the neural network parameters of the neural network when the objective function is evaluated on a network output generated by the neural network by processing the augmented version of the network input;
determining a combined gradient for the network input by combining the gradients determined for the plurality of augmented versions of the network input; and
generating the clipped gradient for the network input by clipping the combined gradient for the network input; and
updating the neural network parameters using the clipped gradients for the network inputs of the plurality of network inputs.

20. A system comprising one or more computers and one or more storage devices communicatively coupled to the one or more computers, wherein the one or more storage devices store instructions that, when executed by the one or more computers, cause the one or more computers to perform operations comprising:
training a set of neural network parameters of the neural network on a set of training data over a plurality of training iterations to optimize an objective function, comprising, at each training iteration:
sampling a plurality of network inputs from the set of training data;
determining a clipped gradient for each network input of the plurality of network inputs, comprising, for each network input of the plurality of network inputs:
generating a plurality of augmented versions of the network input, wherein each augmented version of the network input results from applying a respective augmentation transformation to the network input;
determining, for each of the plurality of augmented versions of the network input, a gradient of the objective function with respect to the neural network parameters of the neural network when the objective function is evaluated on a network output generated by the neural network by processing the augmented version of the network input;
determining a combined gradient for the network input by combining the gradients determined for the plurality of augmented versions of the network input; and
generating the clipped gradient for the network input by clipping the combined gradient for the network input; and
updating the neural network parameters using the clipped gradients for the network inputs of the plurality of network inputs.
